(19) United States
(12) Patent Application Publication
(10) Pub. No.: US 2017/0248878 A1
(43) Pub. Date: Aug. 31, 2017

(54) ELASTIC ROLL, FIXING DEVICE, IMAGE FORMING APPARATUS, AND BASE

(71) Applicant: FUJI XEROX CO., LTD., Tokyo (JP)

(72) Inventor: Ryosuke KUBOTA, Ebina-shi (JP)

(73) Assignee: FUJI XEROX CO., LTD., Tokyo (JP)

(21) Appl. No.: 15/233,706

(22) Filed: Aug. 10, 2016

(30) Foreign Application Priority Data
Feb. 29, 2016 (JP) 2016-037939

(51) Int. Cl. G03G 15/20

(52) U.S. Cl. CPC G03G 15/206; G03G 15/2089

(57) ABSTRACT

According to an aspect of the invention, an elastic roll includes a base that has a circular outer circumferential line in an axial direction and includes an outer circumferential surface on which a spiral recess in the axial direction is formed; and an elastic layer that is provided to be adhered to the outer circumferential surface and has a circular outer circumferential line in the axial direction.

### CROSS-REFERENCE TO RELATED APPLICATIONS

This application is based on and claims priority under 35 USC 119 from Japanese Patent Application No. 2016-037939 filed Feb. 29, 2016.

### BACKGROUND

### Technical Field

The invention relates to an elastic roll, a fixing device, an image forming apparatus, and a base.

### SUMMARY

According to an aspect of the invention, there is provided an elastic roll including a base that has a circular outer circumferential line in an axial direction and includes an outer circumferential surface on which a spiral recess in the axial direction is formed, and an elastic layer that is provided to be adhered to the outer circumferential surface and has a circular outer circumferential line in the axial direction.

### BRIEF DESCRIPTION OF THE DRAWINGS

Exemplary embodiments of the present invention will be described in detail based on the following figures, wherein:

FIG. 1 is a schematic view of an image forming apparatus of the exemplary embodiment in a plan view;

FIG. 2 is a sectional view of a fixing device configuring the image forming apparatus of the exemplary embodiment;

FIG. 3 is a schematic view for illustrating that the entire outer circumference is within a range of a predetermined diameter in a radial direction, in a case where a pressure roll configuring the fixing device of the exemplary embodiment is seen in an axial direction;

FIG. 4 is a diagram of a part of the pressure roll of the exemplary embodiment and is a sectional view when the pressure roll is cut along a virtual plane which is orthogonal to a radial direction of the pressure roll and includes an axis of the pressure roll;

FIG. 5A is a diagram showing a part of a shaft configuring the pressure roll of the exemplary embodiment and is a diagram (front view) when the shaft is seen in an axial direction;

FIG. 5B is a sectional view taken along a cut section 5A-5A of FIG. 4;

FIG. 6 is a diagram showing a manufacturing method of a heating roll of the exemplary embodiment and is a schematic view showing a state where the shaft is disposed in a die and liquid flows from an inlet formed in the die;

FIG. 7 is a diagram showing a manufacturing method of a heating roll of a comparative embodiment and is a schematic view showing a state where the shaft is disposed in a die and liquid flows from an inlet formed in the die;

FIG. 8A is a diagram showing a part of a pressure roll configuring a fixing device of the comparative embodiment and is a sectional view when the pressure roll is cut along a virtual plane which is orthogonal to a radial direction of the pressure roll and includes an axis of the pressure roll;

FIG. 8B is a schematic view for illustrating that some parts of the entire outer circumference is not within a range of a predetermined diameter in a radial direction, in a case where a pressure roll of the comparative embodiment is seen in an axial direction; and

FIG. 9 is a table showing configurations of shafts of the pressure rolls and evaluation results of the examples and comparative examples.

### DETAILED DESCRIPTION

Outline

Hereinafter, an embodiment for realizing the invention (exemplary embodiment) will be described. Next, examples will be described.

In the following description, a direction shown with an arrow X and an arrow −X in the drawings is set as an apparatus width direction, a direction shown with an arrow Z and an arrow −Z in the drawings is set as an apparatus height direction, a direction (arrow Y and arrow −Y direction) orthogonal to the apparatus width direction and the apparatus height direction is set as an apparatus depth direction.

### Exemplary Embodiment

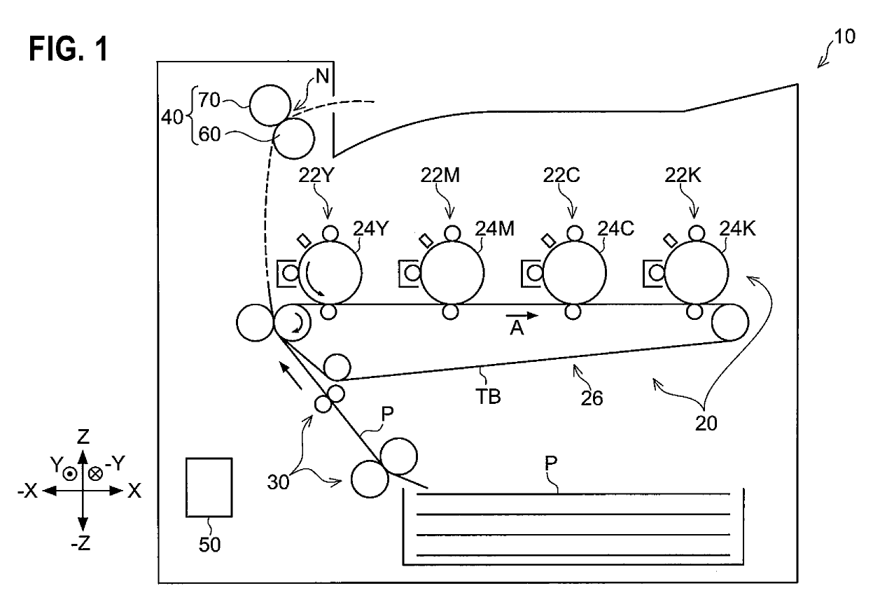

Hereinafter, the exemplary embodiment will be described with reference to the drawings. First, the overall configurations and an image forming operation of an image forming apparatus 10 (see FIG. 1) of the exemplary embodiment will be described. Next, a configuration of a main part (fixing device 40) of the exemplary embodiment and a manufacturing method (hereinafter, manufacturing method of the exemplary embodiment) of a pressure roll 72 configuring the fixing device 40 will be described. Next, the operation of the exemplary embodiment will be described.

Overall Configuration of Image Forming Apparatus

As shown in FIG. 1, the image forming apparatus 10 is an electrophotographic apparatus including a toner image forming unit 20, a transport device 30, a fixing device 40, and a control unit 50.

Toner Image Forming Unit

The toner image forming unit 20 performs each process of charging, exposing, developing, and transfer, and has a function of forming a toner image (not shown) fixed to a medium P by the fixing device 40, on the medium. Here, the toner image forming unit 20 is an example of a forming unit. The toner image is an example of an image. The toner image forming unit 20 includes each monochromatic unit 22 (monochromatic units 22Y, 22M, 22C, and 22K) and a transfer device 26.

Each monochromatic unit 22 has a function of forming a toner image containing colors (Y (yellow), M (magenta), C (cyan), and K (black)) which is primarily transferred to a belt TB which will be described later, on each photoreceptor 24 (photoreceptors 24Y, 24M, 24C, and 24K).

The transfer device 26 has a function of primarily transferring a toner image formed on each photoreceptor 24 to the endless belt TB which rotates in an arrow A direction and secondarily transferring the toner image held on the belt TB to the medium P.

Transport Device

The transport device 30 has a function of transporting the medium P.

Fixing Device

The fixing device 40 has a function of fixing the toner image formed on the medium P by the toner image forming unit 20 to the medium P. Since the fixing device 40 is a main part of the exemplary embodiment, the fixing device 40 will be described later.

Control Unit

The control unit 50 has a function of controlling each unit configuring the image forming apparatus 10 other than the control unit 50. The function of the control unit 50 will be described in the description of the image forming operation which will be described later.

Hereinabove, the overall configuration of the image forming apparatus 10 of the exemplary embodiment has been described.

Image Forming Operation

Next, the image forming operation will be described with reference to FIG. 1.

The control unit 50 which receives image data from an external apparatus (not shown) operates each unit configuring the image forming apparatus 10 other than the control unit 50.

When the toner image forming unit 20 is operated, a toner image having each color is formed on each photoreceptor 24 by each monochromatic unit 22, the toner image formed on each photoreceptor 24 is primarily transferred to the belt TB by the transfer device 26, and the toner image which is primarily transferred to the belt TB is secondarily transferred to the medium P which is transported by the transport device 30.

Next, the medium P on which the toner image is formed by the toner image forming unit 20 is transported to the fixing device 40 by the transport device 30.

Then, when the fixing device 40 is operated and the medium P on which the toner image is formed is transported to the fixing device 40, the toner image formed on the medium P is fixed to the medium P (image is formed on the medium P).

The medium P on which the image is formed is discharged to the outside of the image forming apparatus 10 by the transport device 30 to end the image forming operation.

Hereinabove, the image forming operation of the exemplary embodiment has been described.

Configuration of Main Part (Fixing Device 40)

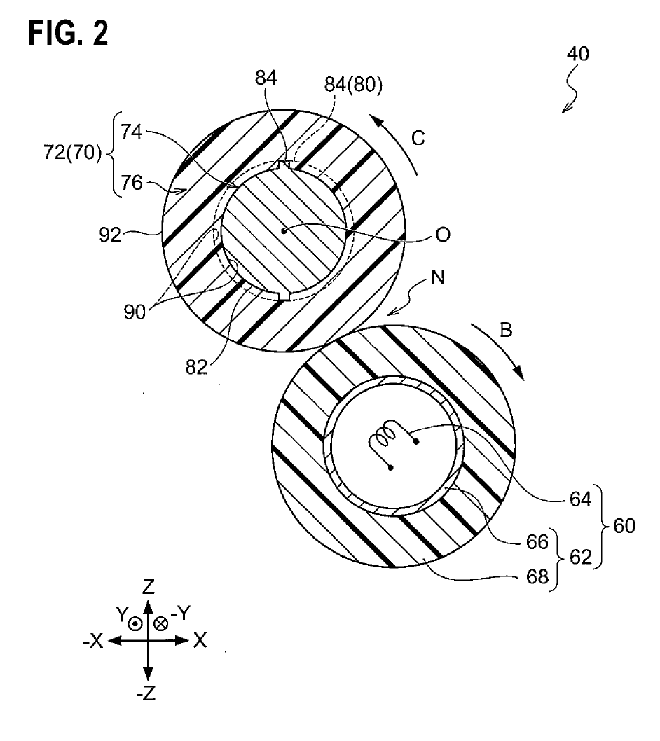

Next, the configuration of the fixing device 40 will be described with reference to the drawing. As shown in FIG. 2, the fixing device 40 includes a heating unit 60, a pressure unit 70, a driving source (not shown). The fixing device 40 has an elongated shape and is fixed to a housing (not shown) of the image forming apparatus 10 in a state where a longitudinal direction thereof is set along the apparatus depth direction. FIG. 2 is a sectional view when the center part of the fixing device 40 in the longitudinal direction is cut along a virtual plane (cut section) orthogonal to the apparatus depth direction.

Heating Unit

As shown in FIG. 2, the heating unit 60 includes a heating roll 62 and a heating source 64. The heating roll 62 includes an elongated pipe 66 and a cylindrical elastic layer 68 which covers the entire area of the outer circumferential surface of the pipe 66. The heating roll 62 is disposed along the apparatus depth direction. A gear (not shown) is fit to one edge of the pipe 66 and a flange (not shown) is fit to the other edge thereof. A driving force from a driving source (not shown) is transferred through the gear and the heating roll 62 is configured to be rotatable around an axis (arrow B direction). The heating source 64 is disposed in the pipe 66. The heating roll 62 has a function of rotating around an axis and heating the medium P by contacting with the medium P which passes through a nip N formed with the pressure roll 72 which will be described later on which a toner image is formed. Here, the heating roll 62 is an example of a heating member.

Pressure Unit

As shown in FIG. 2, the pressure unit 70 includes the pressure roll 72 and a pressing member (not shown). The pressure roll 72 includes an elongated shaft 74 and a cylindrical elastic layer 76 which covers the entire area of an outer circumferential surface 80 of the shaft 74. The pressure roll 72 is disposed along the heating roll 62. A gear (not shown) is fit to one edge of the shaft 74 and a flange (not shown) is fit to the other edge thereof. A driving force from the gear of the heating unit 60 is transferred through a gear in a state where the pressure roll is pressed against the heating roll 62 by a pressing member (not shown), and the pressure roll 72 is configured to be rotatable around an axis (arrow C direction). The pressure roll 72 has a function of rotating around an axis, forming the nip N with the heating roll 62 by contacting with the heating roll 62 which is a contact target, and pressurizing the medium P which passes through the nip N and on which a toner image is formed. Here, the pressure roll 72 is an example of an elastic roll and a pressure member. The shaft 74 is an example of a base.

Shaft

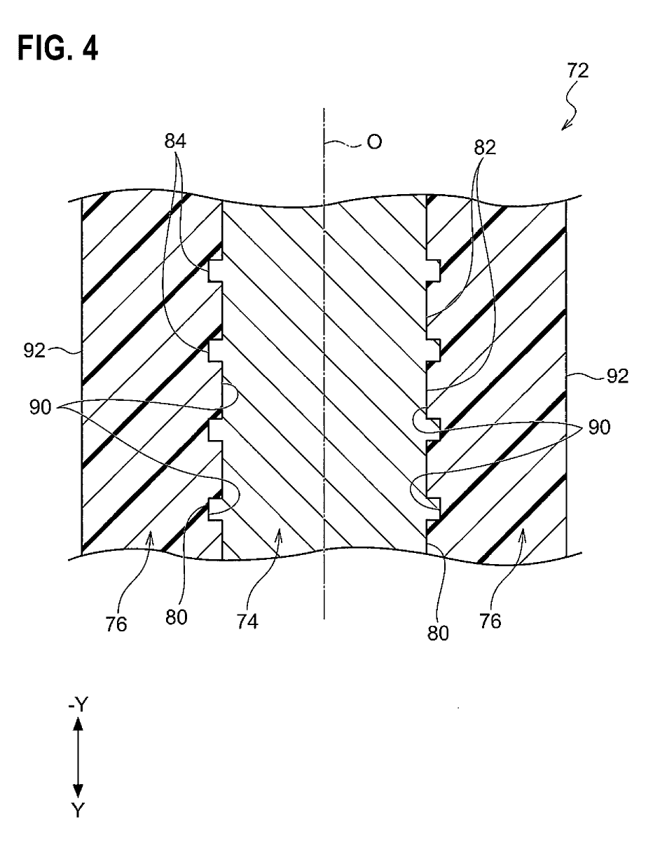

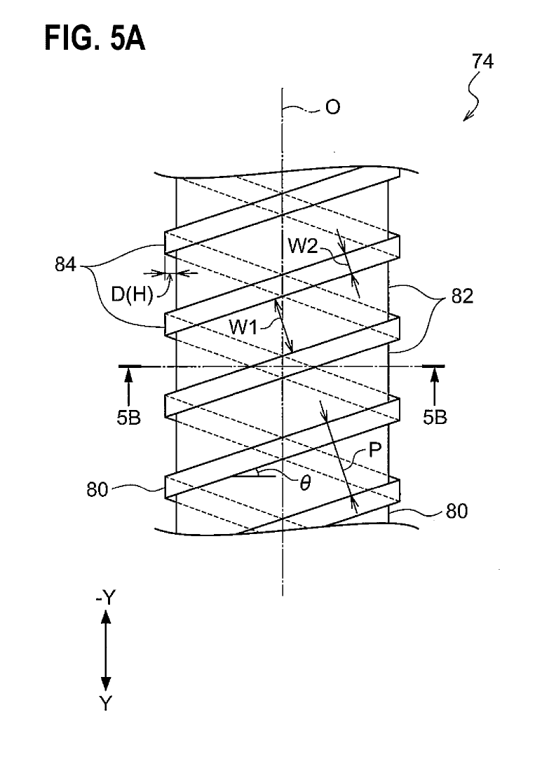

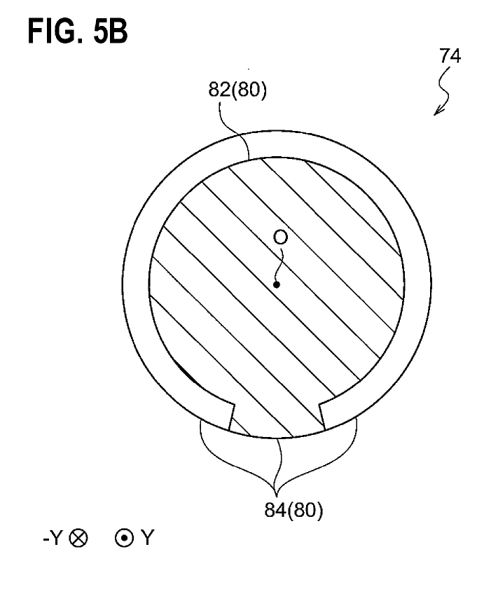

As shown in FIG. 2, FIG. 4, FIG. 5A, and FIG. 5B, a spiral recess 82 in an axial direction (reference numeral O in the drawing means an axis) is formed on the outer circumferential surface 80 of the shaft 74. That is, the shaft 74 includes the outer circumferential surface 80 in which the spiral recess 82 in the axial direction is formed. Here, the recess 82 is set as a recess in which a shape of a cross section orthogonal to a spiral direction is rectangle, for example (see FIG. 4 and FIG. 5A). The spiral direction of the recess 82 is a direction tilted by 30° with respect to the axial direction, for example (that is, the spiral direction θ in FIG. 5A is set as 30°). A width W 1 of the recess 82 (width in a direction orthogonal to the spiral direction) is set as 8 mm, for example. A depth D of the recess 82 is set as 100 μm, for example. A pitch P of the recess 82 in the axial direction (gaps between adjacent recesses 82) is set as 10 mm, for example. A part of the shaft 74 where the recess 82 of the outer circumferential surface 80 is formed is, for example, a part from one edge to the center of the shaft 74 in the axial direction (not shown). The spiral-shaped recess 82 has, for example, a double-line spiral structure. As described above, as shown in FIG. 5B, an outer circumferential line of the shaft 74, when the shaft 74 is seen in the axial direction, is set as a circle having the axis O as the center of the radius.

When the outer circumferential surface 80 of the shaft 74 is seen from a different point, it can be said that a spiral projection 84 in the axial direction is formed on the outer circumferential surface 80 of the shaft 74. By doing so, the projection 84 is, for example, a projection in which a shape of a cross section orthogonal to a spiral direction is rectangle, the spiral direction is set as a direction tilted by 30° with respect to the axial direction, a width W2 is set as 2 mm, a height H is set as 100 μm, and the pitch P is set as 10 mm (see FIG. 2, FIG. 4, FIG. 5A and FIG. 5B). A part of the shaft 74 where the projection 84 of the outer circumferential surface 80 is formed is, for example, a part from one edge to the center of the shaft 74 in the axial direction (not shown). A broken line (hidden line) of the pressure roll 72 in FIG. 2 is an outer circumferential line formed by the projection 84 and is set as a circle having the axis O as the center of the radius.

Elastic Layer

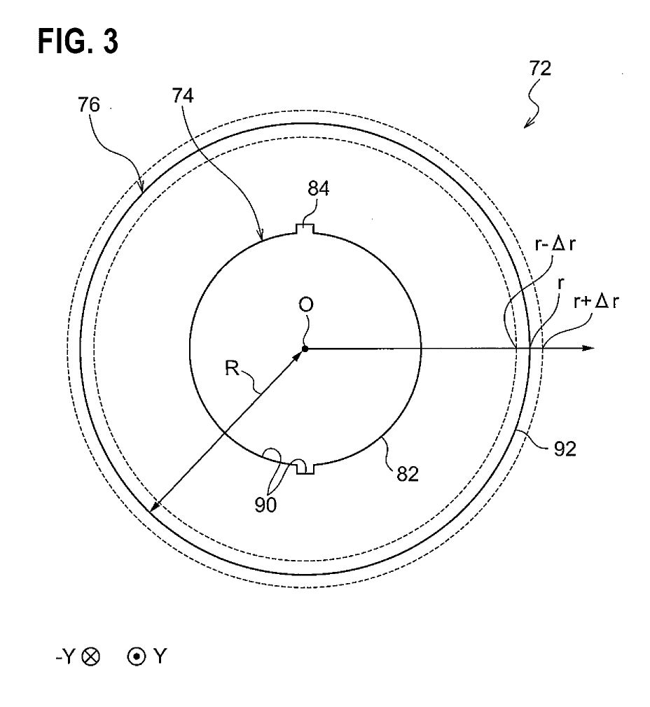

As described above, the elastic layer 76 has a cylindrical shape and covers the entire area of the outer circumferential surface 80 of the shaft 74 with an inner circumferential surface 90. When the elastic layer 76 is seen in the axial direction, the edge (outer circumferential edge) of an outer circumferential surface 92 has a circular shape in a state of configuring the pressure roll 72 with the shaft 74. That is, the elastic layer 76 is provided on the outer circumferential surface 80 of the shaft 74 and the outer circumferential edge in the axial direction has a circular shape. Here, the expression that “the outer circumferential edge has a circular shape” means that a radius R of the pressure roll 72 (distance from the axis O to the outer circumferential surface 92 of the elastic layer 76 in the radial direction) is within a predetermined range in any part of the pressure roll 72. The predetermined range of the radius R of the exemplary embodiment is, for example, from 49.4 mm to 50.6 mm. That is, as shown in FIG. 3, the predetermined range of the exemplary embodiment is a range of r−Δr to r+Δr, when a reference numeral r is set as 50 mm and a reference numeral Δr is set as 0.6 mm.

As shown in FIG. 4, the elastic layer 76 covers the entire area of the outer circumferential surface 80 of the shaft 74, in a state where the inner circumferential surface 90 is adhered to the outer circumferential surface 80 of the shaft 74, that is, in a state where gaps are not formed between the elastic layer 76 and the outer circumferential surface 80 of the shaft 74. That is, the elastic layer 76 is adhered to the entire area of the outer circumferential surface 80 of the shaft 74 (embedded into the spiral recesses 82) to cover the entire area of the outer circumferential surface 80 of the shaft 74.

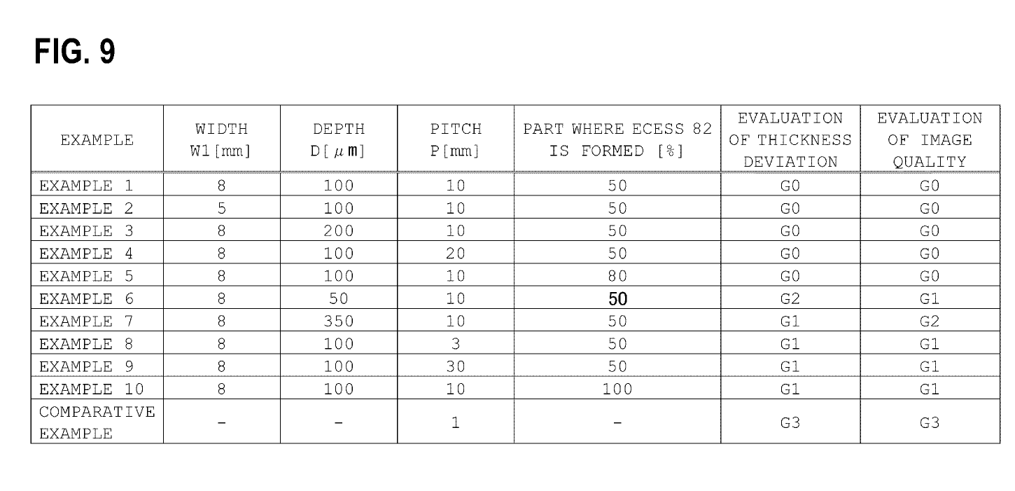

Hereinabove, the configuration of the main part (fixing device 40) of the exemplary embodiment has been described. The pressure roll 72 of the exemplary embodiment corresponds to Example 1 which will be described later (see FIG. 9).

Manufacturing Method of Pressure Roll

Next, the manufacturing method of the exemplary embodiment will be described.

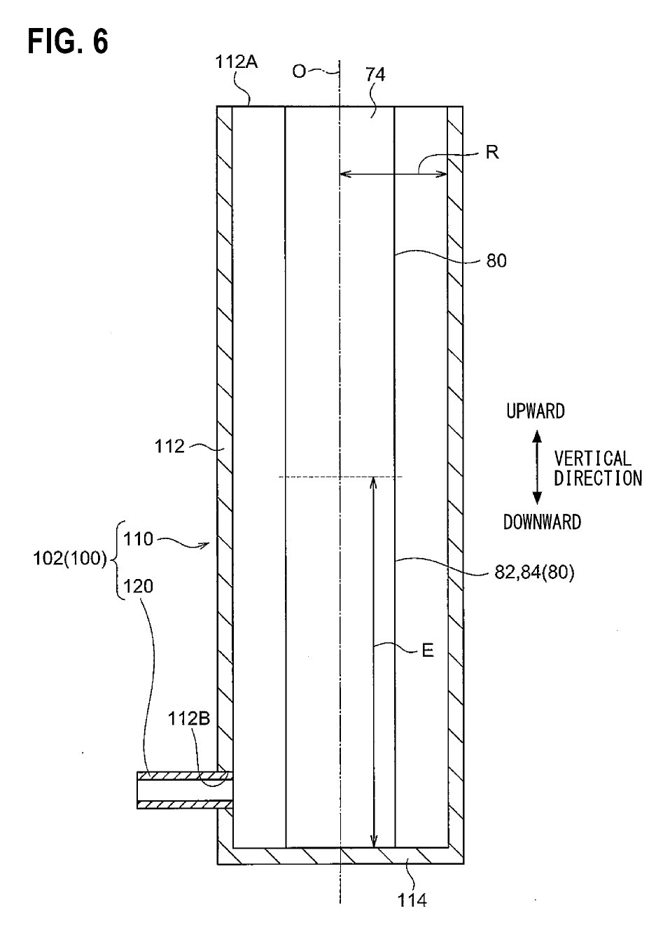

The manufacturing method of the exemplary embodiment is performed by using a molding apparatus 100 shown in FIG. 6. The molding apparatus 100 includes a die 102, an injecting device (not shown), and a vulcanizing device (not shown). The die 102 includes a cylinder 110 and an injecting unit 120 for injecting liquid (not shown) into the cylinder 110. The cylinder 110 includes a circumferential wall 112 and a bottom 114 provided at one edge, and an opening (inlet) 112A is formed on the other edge. An inner diameter (radius of inner circumference) of the cylinder 110 is equivalent with the radius R of the pressure roll 72. An opening 112B is formed in the circumferential wall 112 on the bottom 114 side. The injecting unit 120 has a cylindrical shape. One edge thereof is fit to the opening 112B and liquid for forming an elastic layer is injected from the injecting device through the other edge. The molding apparatus 100 is disposed so that the opening 112A is on the upper side in a vertical direction. Liquid is, for example, liquid rubber having viscosity of 200 Pa·s, that is, liquid rubber having high viscosity.

In the manufacturing method of the exemplary embodiment, an operator (or a robot (not shown)) disposes the shaft 74 in the cylinder 110 so that an axis of the cylinder 110 and an axis of the shaft 74 overlap with each other, and fixes the shaft 74 to the bottom 114 of the cylinder 74. In this case, an operator (or a robot) sets a part of the shaft 74 where the recess 82 is formed on the outer circumferential surface 80 (part of a reference numeral E in FIG. 6) on the lower side. Then, an operator (or a robot) injects liquid into the cylinder 110 from the injecting unit 120 by using the injecting device. When the liquid level of the liquid injected into the cylinder 110 approach a determined position in a vertical direction (a position of the opening 112A of the cylinder 110 in the vertical direction, for example), an operator (or a robot) stops the injection of the liquid performed using the injecting device. Then, an operator (or a robot) vulcanizes the liquid in the cylinder 110 using the vulcanizing device. The liquid is vulcanized on the outer circumferential surface 80 of the shaft 74, the shaft 74 is removed from the die 102 by an operator (or a robot), and the processes in the manufacturing method of the exemplary embodiment are completed.

Hereinabove, the manufacturing method of the exemplary embodiment has been described.

Operation

Next, the operation of the exemplary embodiment will be described. Hereinafter, the operation of the exemplary embodiment will be described with reference to the drawing, while comparing the exemplary embodiment with the comparative embodiment described below. Even in a case of not showing in the drawing in a case of using the components used in the exemplary embodiment, in the comparative embodiment, the reference numerals and names of the components are used as they are.

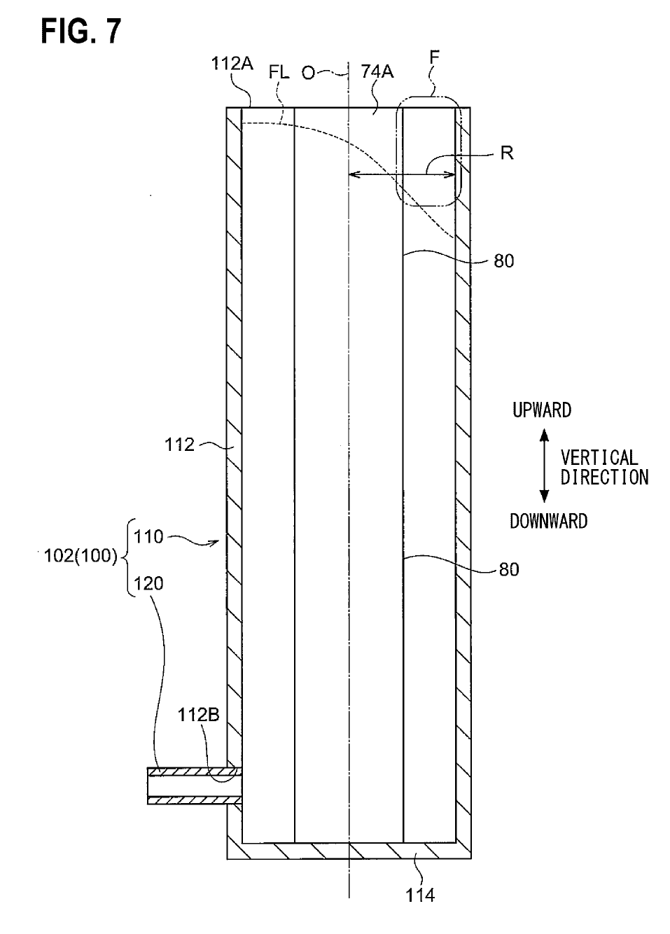

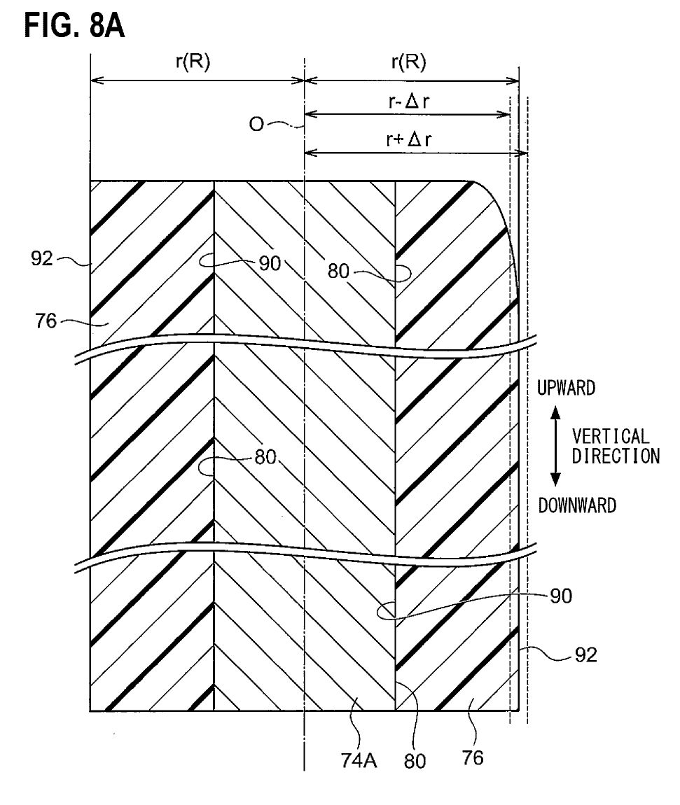

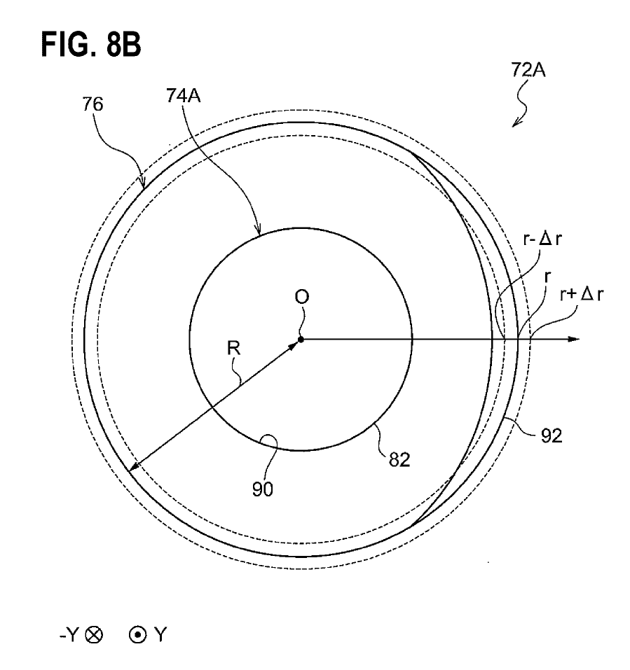

A shaft 74A of the comparative embodiment (see FIG. 7, FIG. 8A and FIG. 8B) is different from the shaft 74 of the exemplary embodiment (see FIG. 2, FIG. 3, FIG. 4, FIG. 5A, FIG. 5B, and FIG. 6), and the recess 82 is not formed on the outer circumferential surface 80. Accordingly, in the shaft 74A of the comparative embodiment, vertical sections of each part in the axial direction from one edge to the other edge thereof in the axial direction have a circular shape having the same diameter. The configuration of a pressure roll 72A of the comparative embodiment is the same as the configuration of the pressure roll 72 of the exemplary embodiment, except for the above point.

As shown in FIG. 7, a manufacturing method of the pressure roll 72A of the comparative embodiment (hereinafter, manufacturing method of the comparative embodiment) is performed in the same manner as in the manufacturing method of the exemplary embodiment, except for using the shaft 74A of the comparative embodiment, instead of the shaft 74 of the exemplary embodiment. The pressure roll 72A of the comparative embodiment corresponds to a comparative example which will be described later (see FIG. 9).

As described above, the spiral recess 82 (or spiral projection 84) is not formed on the outer circumferential surface 80 of the shaft 74A of the comparative embodiment. Accordingly, in a case of the manufacturing method of the comparative embodiment, when liquid (having high viscosity) is injected into the cylinder 110, the liquid may spill over, before a part of a gap between the shaft 74A and the circumferential wall 112 of the cylinder 110 which is farthest from the opening 112B is filled with the liquid. Here, a part f a gap between the shaft 74A and the circumferential wall 112 of the cylinder 110 which is farthest from the opening 112B is a part F surrounded with an alternate long and two short dashes line in FIG. 7. The part F corresponds to a part on the upper portion of the gap between the shaft 74A and the circumferential wall 112 of the cylinder 110 and a part on a side opposite to the opening 112B with the shaft 74A interposed therebetween in the vertical direction. A broken line FL of FIG. 7 shows the liquid level of the liquid in a process in which the liquid is injected up to the upper side in the cylinder 110 (opening 112A side). In a case of the manufacturing method of the comparative embodiment, when the liquid (having high viscosity) is injected into the cylinder 110 at an injection rate (injection amount of liquid per unit time) lower than that in the case of the exemplary embodiment, the liquid does not spill over, and the part of the gap between the shaft 74A and the circumferential wall 112 of the cylinder 110 which is farthest from the opening 112B can be filled with the liquid. However, in this method, productivity of the pressure roll 72 decreases.

As shown in FIG. 8A and FIG. 8B, in the pressure roll 72A manufactured by the manufacturing method of the comparative embodiment, the radius R of the elastic layer 76 in a part other than a part corresponding to the part F at the time of manufacturing is within a predetermined range. However, in the pressure roll 72A, the radius R of the elastic layer 76 corresponding to the part F at the time of manufacturing is smaller than the lower limit r−Δr. In this specification, the state where a part of the radius R is not within the predetermined range as described above is referred to as a thickness deviation state. That is, it can be said that the thickness deviation of the elastic layer 76 occurs in the pressure roll 72A manufactured by the manufacturing method of the comparative embodiment.

With respect to this, in a case of the exemplary embodiment, as shown in FIG. 5A, the spiral recess 82 (or spiral projection 84) in the axial direction is formed on the outer circumferential surface 80 of the shaft 74. Accordingly, in a case of the manufacturing method of the exemplary embodiment, the liquid (having high viscosity) injected into the cylinder 110 from the opening 112B flows while rotating in the axial direction around the shaft 74 along the spiral direction of the spiral recess 82 (or spiral projection 84). Accordingly, in a case of the exemplary embodiment, even when the height of the liquid level of the liquid in the cylinder 110 is higher (liquid level is closer to the opening 112A), compared to the case of the comparative embodiment, the height of each liquid level in a circumferential direction of the shaft 74 easily becomes the equivalent height, regardless of a relationship with the opening 112B. As a result, in the case of the exemplary embodiment, the liquid level easily approaches the position of the opening 112A while setting the height of each liquid level in a circumferential direction of the shaft 74 to be equivalent, unlike the case of the comparative embodiment.

Accordingly, in a case where the shaft 74 of the exemplary embodiment configures an elastic roll including the elastic layer 76 on the outer circumferential surface 80, the thickness deviation of the elastic layer 76 is prevented (the outer diameter thereof is within the predetermined range in any part of the elastic roll), compared to a case of using a shaft in which vertical sections of each part in the axial direction from one edge to the other edge thereof in the axial direction have a circular shape having the same diameter. That is, in the pressure roll 72, the thickness deviation of the elastic layer 76 is prevented, compared to a case of using a pressure roll including a shaft in which vertical sections of each part in the axial direction from one edge to the other edge thereof in the axial direction have a circular shape having the same diameter. In addition, in the fixing device 40 of the exemplary embodiment, fixing failure (failure due to variation in pressing force of the pressure roll 72 in the axial direction) is prevented, compared to a case of using a fixing device including an elastic roll in which the heating roll 62 and the pressure roll 72 include a shaft in which vertical sections of each part in the axial direction from one edge to the other edge thereof in the axial direction have a circular shape having the same diameter. In the image forming apparatus 10 of the exemplary embodiment, image forming failure due to fixing failure is prevented, compared to a case of using an image forming apparatus including an elastic roll elastic roll in which the heating roll 62 and the pressure roll 72 include a shaft in which vertical sections of each part in the axial direction from one edge to the other edge thereof in the axial direction have a circular shape.

Hereinabove, the operation of the exemplary embodiment has been described.

### Examples

Next, the examples will be described with reference to the drawings. In the examples and comparative examples, in a case of using the same components as the components used in the exemplary embodiment and the comparative embodiment, the reference numerals of the components are used as they are.

Evaluation Method

Regarding the pressure roll 72 of the example (Examples 1 to 10) and the pressure roll 72 of a comparative example of a table of FIG. 9, evaluation of thickness deviation and evaluation of image quality are performed.

Evaluation of Thickness Deviation

In the evaluation of the thickness deviation, the outer diameters (radius R) of the pressure roll 72 of the example (Examples 1 to 10) and the pressure roll 72A of a comparative example of a table of FIG. 9 are measured. The measurement is performed by using an outer diameter measuring device 52B/750 (manufactured by Tokyo Seimitsu Co., Ltd.). The radius R of the elastic layer 76 of a part corresponding to the part F at the time of manufacturing in the pressure roll 72 and the pressure roll 72A (hereinafter, referred to as radius FR) is evaluated with four levels. Here, four levels are G0, G1, G2, and G3 in the order of high evaluation. G0 indicates a case where the minimum value of the radius FR is within the predetermined range (from 49.8 mm to 50.2 mm), G1 indicates a case where the minimum value of the radius FR is equal to or greater than 49.6 mm and smaller than 49.8 mm, G2 indicates a case where the minimum value of the radius FR is equal to or greater than 49.4 mm and smaller than 49.6 mm, and G3 indicates a case where the minimum value of the radius FR is smaller than 49.4 mm. In the evaluation of the thickness deviation, G0, G1, and G2 are acceptable, and G3 is not acceptable.

Evaluation of Image Quality

In the evaluation of the image quality, a pressure member of a fixing device of Docuprint CP400 (manufactured by Fuji Xerox Co., Ltd.) is remodeled so as to replace the pressure member with the pressure roll 72 of the exemplary embodiment and the pressure roll 72A of the comparative embodiment, a color image having density of 5% and configured with Y, M, C, and K is formed on an A4-sized medium P, and the evaluation is visually performed by dividing the level of the image quality into four levels. Here, four levels are G0, G1, G2, and G3 in the order of high evaluation. G0 indicates a case where it is determined that image spots are not generated, G1 indicates a case where it is determined that image spots are slightly generated, G2 indicates a case where it is determined that image spots are clearly (in a clearly recognizable level more than a faint level) generated, and G2 indicates a case where it is determined that image spots are significantly (in a clearly recognizable level more than the clear level) generated. In the evaluation of the image quality, G0, G1, and G2 are acceptable, and G3 is not acceptable.

Details of Examples and Comparative Example

The details of Examples 1 to 10 are as in FIG. 9. Here, the width W1, the depth D, and the pitch P are as described above. The part where the recess 82 is formed (%) means a state where the recess 82 is formed up to a position of 50% of the length of the shaft 74 from one edge to the other edge of the shaft 74, in a case where the length of the shaft 74 is set as 100%. That is, when the part where the recess 82 is formed (%) is 50%, it means that the recess 82 is formed from one edge to the center of the shaft 74. When the part where the recess 82 is formed (%) is 100%, it means that the recess 82 is formed from one edge to the other edge of the shaft 74. The comparative example has the same configuration as the comparative embodiment described above (see FIG. 7, FIG. 8A, and FIG. 8B).

Results

As shown in the table of FIG. 9, all of Examples 1 to 10 is acceptable examples in the evaluation of the thickness deviation and the evaluation of the image quality. With respect to this the comparative example is not acceptable example in the evaluation of the thickness deviation and the evaluation of the image quality.

Consideration

As shown in the results described above, Examples 1 to 10 corresponding to the exemplary embodiment exhibit the operation of the exemplary embodiment described above.

Hereinabove, the examples has been described.

As described above, the invention has been described using the specific embodiment as an example, but the invention is not limited to the exemplary embodiment described above. The technical scope of the invention also includes the following embodiments, for example.

In the exemplary embodiment, the pressure roll 72 has been described as an example of the elastic roll. However, a heating roll may be manufactured using the manufacturing method of the exemplary embodiment by forming a spiral recess (or spiral projection) on an outer circumferential surface of the pipe 66. In this case, the pipe 66 is an example of the base, the heating roll is an example of the elastic roll, and the pressure roll is an example of a contact target. A fixing device (not shown) including the heating roll exhibits the operation of the exemplary embodiment. That is, the fixing device including the heating roll is included in the technical scope of the invention.

In the exemplary embodiment, in the spiral recess 82 (or spiral projection 84), a shape of a cross section orthogonal to a spiral direction has been described as rectangle. However, the shape of the cross section thereof may not be a rectangle, as long as it is a shape of a spiral recess or projection. For example, the shape of the cross section may be a semicircle, a triangle, and other shapes.

In the exemplary embodiment, the pitch P of the spiral recess 82 (or spiral projection 84) has been described as constant in a part of the shaft 74 where the recess 82 of the outer circumferential surface 80 is formed. However, the pitch P may not be constant, as long as a spiral recess or spiral projection is formed in the part described above.

In the exemplary embodiment, the spiral recess 82 (or spiral projection 84) has been described to have a double spiral shape. However, the spiral recess 82 (or spiral projection 84) may have a single or three-line spiral structure.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An elastic roll comprising:
a base that has a circular outer circumferential line in an axial direction and includes an outer circumferential surface on which a spiral recess in the axial direction is formed; and
an elastic layer that is provided to be adhered to the outer circumferential surface and has a circular outer circumferential line in the axial direction.

2. A fixing device comprising:
a heating member that heats a medium by contacting the medium on which an image is formed; and
a pressure member that forms a nip along with the heating member to press the medium passing through the nip,
wherein at least one of the heating member and the pressure member is the elastic roll according to claim 1.

3. An image forming apparatus comprising:
the fixing device according to claim 2, and
a forming unit that forms an image fixed to a medium by the fixing device, on a medium.

4. A base that has a circular outer circumferential line in an axial direction and includes an outer circumferential surface on which a spiral recess in the axial direction is formed,
wherein the base configures is configured as a shaft for an elastic roll which forms a nip with a contact target by contacting with the contact target, and heats and presses a medium for fixing an image to the medium by nipping the medium on which the image is formed and which passes through the nip.

5. The elastic roll according to claim 1, wherein:
the base is a shaft; and
the elastic layer covers an entire outer circumferential surface of the shaft.
